(19) United States
(12) Patent Application Publication
(10) Pub. No.: US 2006/0286415 A1
(43) Pub. Date: Dec. 21, 2006

(54) Regulation of the water balance in fuel cell systems

(75) Inventors: Jens Muller, Munich (DE); Marcus Preissner, Munich (DE); Christian Bohm, Siegertsbrunn (DE); Volker Harbusch, Munich (DE)

Correspondence Address: IP STRATEGIES, 12 1/2 WALL STREET, SUITE I, ASHEVILLE, NC, 28801, US

(73) Assignee: SFC SMART FUEL CELL AG, BRUNNJTHAL-NORD (DE)

(21) Appl. No.: 10/520,129

(22) PCT Filed: May 16, 2003
(86) PCT No.: PCT/EP03/05196

§ 371 Date: Jul. 11, 2006

(30) Foreign Application Priority Data
Jul. 1, 2002 (EP) 02014557.9

(51) Int. Cl. H01M 8/04

(52) U.S. Cl. 429/13; 429/24; 429/22; 429/26

(57) ABSTRACT

The invention relates to a method for controlling the fluid balance in an anode circuit of a fuel cell system. In this method, at least the gases discharged on the cathode side are cooled in a condensing device in order to obtain a condensed liquid, and the condensed liquid is fed to the anode circuit of the fuel cell system. It further relates to a fuel cell system designed according to the principles of the inventive method.

### FIELD OF THE INVENTION

The invention relates to a method for regulating the fluid balance in an anode circuit of a fuel cell system. In this method, at least the gases discharged on the cathode side are cooled in a condensing device in order to obtain a condensed liquid, and the condensed liquid is fed to the anode circuit of the fuel cell system. An active cooling of the anode circuit is not necessary.

### PRIOR ART

Numerous fuel cell systems use instead of pure fuel on the anode side a fuel mixture, as a rule diluted with water which is depleted when passing the fuel cell. Examples of such fuels are methanol, ethanol, trioxane, dimethoxymethane, trimethoxymethane, dimethyl ether. However, the depletion is often incomplete, so that at the outlet on the anode side, unspent fuel is also discharged. For utilising this unspent fuel, as well, and for thus being able to dispense with an external water supply, a cycle flow is provided on the anode side where the depleted fuel mixture is again enriched by metered addition of fuel and again fed to the anode side.

However, this cycle flow is no closed cycle: first, reaction products (waste materials) have to be removed from the cycle and spent fuel has to be supplied, and moreover, water losses, which among others arise by water flowing from the anode side to the cathode side (water drag) and being discharged with the waste gas, have to be compensated.

That is, to maintain a constant amount of water in the system or to be able to correct deviations from this amount, a part of the water arising on the cathode side has to be retained and fed again to the anode circuit in a liquid form.

The amount of water actually discharged during the waste gas removal should exactly correspond to the amount of water formed as reaction product or supplied with the cathode gases.

The water removal from the system is effected in the form of waste gases saturated with water vapour and in a liquid form, wherein the latter can be easily fed to the fluid cycle again. Without any further measures, however, due to the heat generation in the system at the waste gas side, more water vapour would arise than could be discharged for maintaining a constant amount of water.

In order to reduce the amount of water arising as water vapour and to achieve a well-balanced water balance, conventionally, the operating temperature of the system is reduced until the amount of water vapour dragged by the waste gases exactly corresponds to the excess amount of water (i.e. the water formed as reaction product or the water supplied from outside, e.g. with the air supply).

For cooling the fuel cell, the cycle flow on the anode side offers itself, which is passed through a heat exchanger after the waste gases have been separated off before it is again fed to the anode.

However, the system temperature necessary for achieving a well-balanced water balance and thus the temperature difference to the surroundings are so low that sufficient heat dissipation can only be achieved by correspondingly large heat exchangers supported by efficient fans. When the ambient temperature rises, the temperature difference decisive for the heat exchange can become so low that even these measures are not sufficient and the system has to be shut down.

### DESCRIPTION OF THE INVENTION

In view of these disadvantages, it is an object of the invention to provide improved methods for controlling the fluid balance on the anode side of fuel cell systems which permit an operation even at relatively high ambient temperatures. It is further an object of the invention to provide corresponding fuel cell systems.

These objects are achieved by the methods with the steps of claims 1 and 2 and by the fuel cell system with the features of claim 5, respectively. Advantageous further developments of the methods/systems according to the invention are listed in the subclaims.

In the method according to the invention for controlling the fluid balance in an anode circuit of a fuel cell system, a measured quantity is determined which is characteristic of the amount of liquid and/or changes in the amount of liquid in the fuel cell system; in response to the determined characteristic measured quantity, the cooling capacity of a condensing device and/or the volume flow rate on the cathode side is/are adjusted; gases discharged on the cathode side are cooled in the condensing device in order to obtain a condensed liquid and feed the same into the anode circuit of the fuel cell system. In an alternative variant, the gases discharged on the anode side, too, are cooled, either together with the gases discharged on the cathode side or in a separate condensing device. Although the amount of water vapour arising on the anode side (per time unit) is normally clearly lower than that on the cathode side, the gas discharged on the anode side has a higher fuel proportion which can be at least partially recovered by the condensation.

In contrast to the conventional control of the fluid balance via the active cooling of the anode circuit where the anode flow and thus indirectly the whole fuel cell are cooled until the liquid proportion of the fluids discharged at the outlets is high enough for maintaining the liquid balance, according to the invention, the liquid proportion of the fluid discharged at the cathode is actively increased for equilibrating the liquid balance. The temperature of the anode flow (or of the whole fuel cell) is not regulated but is effected automatically. That is, in the control of the fluid balance according to the invention, it plays the role of a dependent variable, while it conventionally serves as controlled variable (independent variable).

The invention is not only advantageous in that an active cooling of the fuel cell (that is, for example, of the anode circuit) is no longer necessary. In the method according to the invention, there will rather be a higher temperature level throughout the system, so that the temperature differences between the fluids and the surroundings are higher in the method according to the invention than in the conventional method where the anode circuit is cooled. Due to the higher temperature differences, heat can be dissipated to the surroundings more effectively, so that the heat exchangers of the cooling devices can have smaller dimensions, and/or devices supporting the heat exchange actively, such as fans, can be operated with less energy.

For separating the cathode fluid into a gas and a liquid proportion, a corresponding separating device can be arranged upstream or downstream of the condensing device. However, the condensing device can be designed to fulfil both tasks, i.e. (1) increasing the liquid proportion, and (2) separating the gaseous phase from the liquid. The same applies to the condensing devices of the further developments of the method according to the invention described below.

This is particularly advantageous, if the fluids discharged at the cathode and the anode sides are combined after they have left the fuel cell, and the gas proportion of the combined fluids are cooled in a common condensing device in order to obtain a condensed liquid and feed the same to the anode circuit of the fuel cell system. In this case, only one condensing device is necessary, so that the performance of this preferred further development of the method according to the invention is not more elaborate and expensive than if only the cathode fluids flow through the condensing device.

As external influences (e.g. ambient temperature) and intrinsic processes (e.g. ageing phenomena) can result in changes of the operating properties which can also concern the liquid balance, a control possibility is necessary for controlling the amount of condensed liquid. This can be preferably effected by controlling the cooling capacity of the condensing device(s), for example, by ventilation devices by which the level of the heat exchange with the surroundings can be controlled.

Such changes in the liquid balance can be recognized early with the invention by determining a measured quantity characteristic of changes of the amount of liquid in the fuel cell system and adjusting the cooling capacity of the condensing device(s) in response to the determined characteristic measured quantity. Additionally or alternatively, corrections of the liquid balance can also be performed by adjusting the volume flow rate of the fluid balance on the cathode side in response to the determined characteristic measured quantity.

The changes in the amount of liquid can, for example, be tracked by means of a level sensor in the anode circuit without the absolute value of a change having to be determined. Such a level sensor can be provided in an ascending pipe or alternatively and particularly preferred in an intermediate tank where the liquid to be fed again to the anode circuit is intermediately stored.

In a further development of the above-described methods, the waste gases remaining after the condensing procedure—if only the gases on the cathode side are passed through a condensing device, these are mixed with the waste gases of the anode side—are heated to the temperature of the fuel cell device of the fuel cell system, e.g. in a countercurrent method with the anode and/or cathode flows, which reduces the relative humidity below the saturation value, and they are subsequently passed through a catalytic burner where fuel residues and intermediates are “burnt” for reducing the level of pollutants of the emissions. This procedure is not possible in conventional methods, as there the waste gases essentially have the same temperature as the system itself, so that an adequate reduction of the relative humidity is only possible by a separate heating device and/or by heating the catalytic burner.

Preferably, the catalytic burner can be directly mounted to a fuel cell device in thermal contact therewith and be heated thereby.

The fuel cell system according to the invention comprises a fuel cell device, a device for determining a measured quantity characteristic of the amount of liquid and/or changes of the amount of liquid in the fuel cell system, at least one condensing device for obtaining a condensed liquid at least from gases discharged on the cathode side, a controller for adjusting the cooling capacity of the at least one condensing device and/or the volume flow rate on the cathode side in response to the determined characteristic measured quantity, and a device for feeding the condensed liquid to the anode circuit of the fuel cell system.

The advantages of this system have already been discussed in detail with reference to the corresponding methods, so that a repetition is deemed to be superfluous.

In a particularly preferred further development, the system comprises a heat exchange device for heating gases at the fuel cell device. Additionally or alternatively, a catalytic burner can be provided at or in the fuel cell device and thus be heated by the fuel cell device. Mainly in case of a mounting in the fuel cell device, gases passing through the catalytic burner can be heated in a countercurrent method by the anode and/or cathode fluids.

The advantages of these preferred further developments have also been already discussed for the corresponding methods. For avoiding repetitions, reference is made to the above statements.

Further particularities and advantages of the invention are illustrated below with reference to the Figure and particularly preferred embodiments.

In the drawings:

FIG. 1 shows the schematic structure of a DMFC-system (internal prior art).

FIG. 2 shows an arrangement of a fuel cell system for the application of a first preferred variant of the method according to the invention;

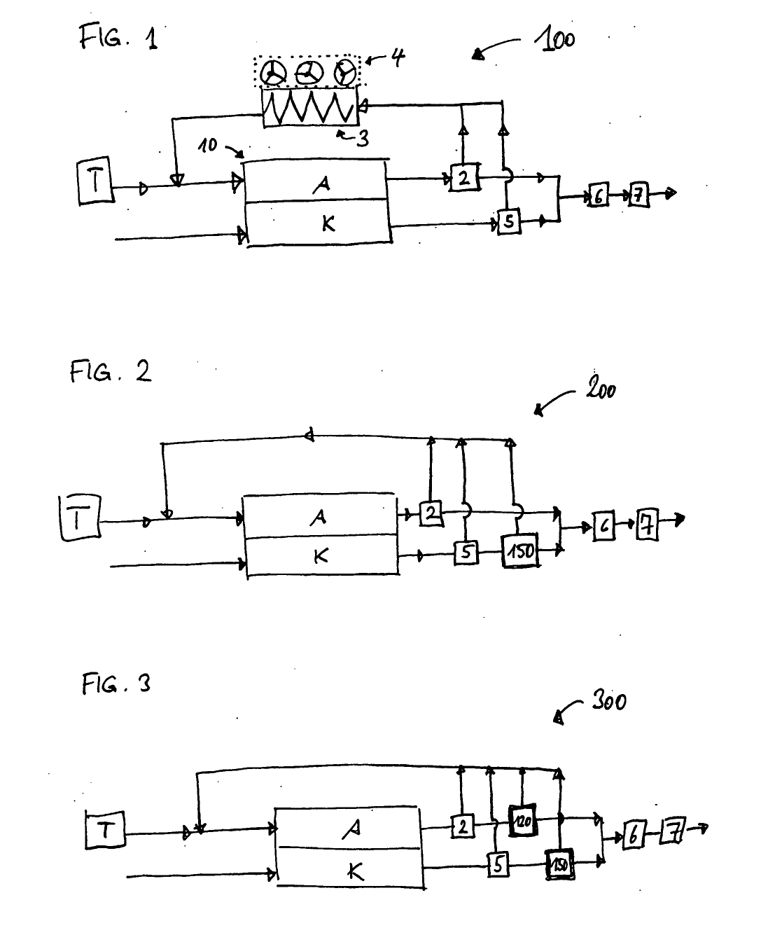

FIG. 3 shows an arrangement of a fuel cell system for the application of a second preferred variant of the method according to the invention;

FIG. 4 shows an arrangement of a fuel cell system for the application of a third preferred variant of the method according to the invention;

FIG. 5 shows a catalytic burner in thermal contact with a fuel cell device;

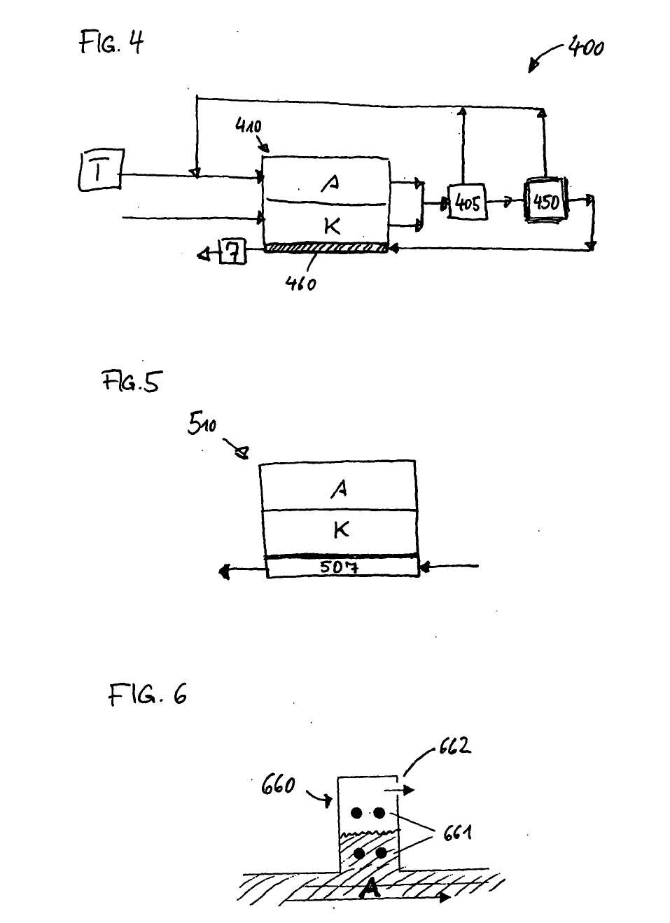

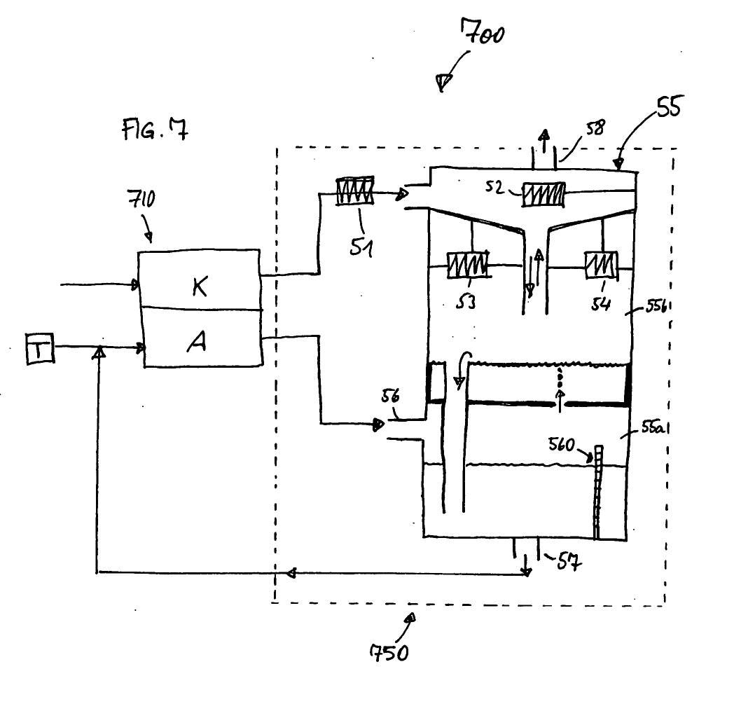

FIG. 6 shows an ascending pipe with a measuring device provided in the anode circuit for determining changes in the liquid balance;

FIG. 7 shows a fuel cell system with an intermediate tank with a level sensor.

FIG. 1 shows the schematic structure of a DMFC (Direct Methanol Fuel Cell) system 100, which is conventionally cooled (as described in the introduction).

A fuel mixture of methanol dissolved in water is fed to anode A of the direct methanol fuel cell 10 which mixture is depleted of methanol when it passes the cell and leaves anode A as anode fluid with liquid proportions and gaseous proportions. In a separating device 2, the liquid proportions are separated from the gaseous proportions, cooled by a cooling device (heat exchanger) 3, enriched with methanol from a fuel supply device T and fed to anode A again.

Thus, the liquid cycle on the anode side is used for cooling the whole system 100. The heat exchanger 3 at ambient temperature cools the liquid discharged at the anode outlet before it is again fed to the anode inlet.

In a compact DMFC system of a low performance range, the mean system temperature in the shown arrangement is about 60° C. In an assumed “normal” ambient temperature of 20° C., the temperature difference to the surroundings is only 40° C., which already puts considerable demands on the heat exchanger 3, the efficiency of which critically depends on the value of this temperature difference.

In order to be able to effect adequate heat dissipation with such low temperature differences at all, the heat exchangers 3 have to be correspondingly large and provided with efficient fans 4.

In case of higher ambient temperatures, which can absolutely achieve and exceed 40° C. (for example, in badly aerated and/or closed rooms or in the sun), the most efficient fans 4 and heat exchangers 3 can possibly no longer guarantee adequate heat dissipation. For safety reasons and for protecting the fuel cell from destruction, normally the manufacturer therefore determines a maximum ambient temperature above which the system must not be operated.

Oxygen is supplied at cathode K, normally by supplying ambient air.

When it passes the cathode space, the oxygen proportion of the supplied gas mixture is reduced; instead, water arising as reaction product on the cathode side or flowing from anode A to cathode K is taken in, so that finally a cathode fluid is discharged which contains unusable air components and water, and can also comprise CO₂ and methanol (e.g. derivatives and reaction intermediates) due to diffusion.

The cathode fluid arising at the outlet also comprises liquid and gaseous proportions which are separated in a further separating device 5. The liquid mainly consists of water and is transferred into the anode circuit for maintaining the water balance of the system 100.

The gases obtained at the cathode and anode sides by the liquid separation are discharged as waste gases. Apart from water vapour, the waste gases comprise the following substances on the cathode side: non-oxidizable air components and residual oxygen as well as carbon dioxide and fuel and/or fuel derivatives which can diffuse from the anode side to the cathode side, the waste gases on the anode side comprise: carbon dioxide (as main component) and unspent fuel and derivatives (obtained as a result of incomplete or parasitic reactions).

The discharge of unspent fuel (or derivatives) to the surroundings is unacceptable for health and safety reasons and has to be avoided. In order to eliminate such emissions, so-called catalytic burners 7 which oxidize unspent fuel and organic by-products with the residual oxygen are employed in the art.

However, the waste gases are normally still saturated with water vapour, i.e. the relative humidity of these waste gases is approximately 100%. However, as with a relative humidity of 100%, a catalytic burner 7 is nearly inefficient (with such a high humidity, in practice some water always condenses and blocks the active catalyst area), the exhaust air stream to be purified has to be heated during and/or before the passage through the catalytic burner 7 with a heating device 6 in order to reduce the relative humidity of the waste gases to a value of much less than 100%.

For cooling the anode circuit (fan!) as well as for heating the waste gases (or alternatively: the catalytic burner), energy is required which reduces the overal efficiency of the system 100.

FIG. 2 shows the schematic structure of a DMFC system 200 in which the water balance is controlled according to the principles of the present invention. In the figure, the same features have been provided with the same reference numerals as in FIG. 1.

Thus, unnecessary repetitions are avoided as far as possible.

The fuel mixture depleted during the passage through anode A of the fuel cell of the DMFC system 200 leaves anode A as anode fluid with liquid proportions and gaseous proportions. A separation of the liquid phase proportions from the gaseous ones follows, the latter being recycled again to the anode inlet.

The fluid flow arising at the outlet at cathode K passes the separating device 5 and subsequently a condensing device 150: In contrast to the separating device 5, the latter does not only effect a mere separation of the liquid and gaseous proportions but increases the amount of liquid at the expense of the amount of gas and mainly more liquid water arises. The complete amount of liquid, that is the proportions of the cathode fluid already discharged in a liquid form (when present) and the amount of liquid condensed by the condensing device 150 are fed into the anode circuit.

Despite a lacking cooling device 3 on the anode side, the system 200 is sufficiently cooled. This is essentially based on the following effects:
feeding the condensed amount of liquid into the anode circuit; this liquid has a lower temperature than the system due to the condensation procedure.
evaporative cooling on the cathode side based on the fact that a part of the water arising on the cathode side or being diffused to the cathode side is evaporated.

If one takes again a compact DMFS system of a low performance range as a basis as illustrative example, the mean system temperature of the arrangement which is shown in FIG. 2 (i.e. the temperature of the anode fluid in the cell) is approximately 80° C. (compared with approximately 60° C. in the arrangement which is shown in FIG. 1 with otherwise the same power data).

With an assumed “normal” ambient temperature of 20° C., the temperature difference to the surroundings is now after all 60° C. This means: when the condensation in the condensing device 150 is based on heat exchange with the surroundings, a clearly increased temperature is available as projecting force for the heat exchange. That is, the heat exchangers of the condensing device 150 can have smaller dimensions and/or be provided with less efficient fans than in the cooling device 3 of FIG. 1.

Even with a high ambient temperature of 40° C., the demands on the heat exchanger are still comparable with the demands on that of FIG. 1 under normal conditions, i.e. at 20° C. That is, due to the arrangement according to the invention, an operation of the DMFC system 200 at relatively high temperatures is possible.

However, the effects achieved according to the invention are not only advantageous with respect to the liquid balance, they have also consequences for the waste gases: In comparison with FIG. 1, these waste gases have a higher temperature in the arrangement of FIG. 2 directly after they have left the system.

The gas temperature does not change or changes at most inessentially in FIG. 1 in the gas/liquid separation operation. It is true that this also applies to the waste gases on the anode side in the arrangement which is shown in FIG. 2, however, the waste gases on the cathode side undergo a temperature reduction due to the condensation cooling.

If the waste gases of the cathode side and the waste gases of the anode side are combined, a mean gas temperature which is below the temperature of the system is achieved.

These waste gases, too, are still saturated with water vapour, so that the simple burning of fuel residues with a catalytic burner 7 is not possible.

In the arrangement which is shown in FIG. 2—as in the previous arrangement of FIG. 1 and the following arrangement of FIG. 3—a heater 6 is therefore provided with which the temperature of the waste gases is increased and thus the relative humidity is reduced below the saturation value.

In a particularly preferred variant of the invention, however, it would be possible here (FIG. 2) and in the arrangement of FIG. 3—but not in the arrangement of FIG. 1!—to reheat these waste gases in contact with the fuel cell, for example in countercurrent, and thus to bring the relative humidity of the waste gas mixture below the saturation value and subsequently feed it to the catalytic burner 7 without a separate heater 6 being required for this. This variant is indicated in the Figure only by FIGS. 4 and 5, it goes without saying, however, that corresponding modifications can also be made in the arrangements of FIGS. 2 and 3.

With the arrangement which is shown in FIG. 2, among others the advantage is achieved over the arrangement of FIG. 1, that under otherwise comparable system conditions the temperature difference between the system and the surroundings is higher in the arrangement (FIG. 2) according to the principles of the present invention than in the conventional arrangement (FIG. 1). In the present case, this is an advantage as the decisive value for the efficiency of heat dissipation is the temperature difference between the source of heat (system) and the heat sink (surroundings). The system temperature, however, is simultaneously not so much increased that there would be a risk of impairments of the operation or that a shortened service life would have to reckoned with.

FIGS. 3 and 4 serve for illustrating particularly preferred further developments of the method according to the invention: The same features have been provided with the same reference numerals as in FIG. 1 or 2, respectively. Thus, unnecessary repetitions of the description are avoided as far as possible.

In the DMFC system 300 of FIG. 3, the fluid flow on the anode side also passes a condensing device 120 after having passed the separating device 2 (in expansion of the method illustrated in FIG. 2).

A similar situation also applies to the DMFC system 400 of FIG. 4. However, in this system, the fluids of the anode side and the cathode side are combined after they have left the fuel cell device 410 and pass a common separating device 405 and a common condensing device 450.

The thus gained liquid is fed into the anode cycle. The gaseous phase is heated in a countercurrent device 460 which is in contact with the fuel cell device 410 (and is preferably even designed as an integral part of the same), and thus it is approximately brought again to the system temperature. Thereby, the relative humidity of the gas is reduced below the saturation value, so that it can be directly fed to a catalytic burner 7. (This procedure step can be also easily implemented in the arrangements shown in FIGS. 2 and 3.) The outlined arrangement of the countercurrent device 460 adjacent to cathode K is not of particular importance; the countercurrent device 460 can rather also be adjacent to anode A or be provided within the fuel cell device 410. The last-mentioned arrangement is often preferred due to the reduced and simplified construction of the outlined arrangement.

FIG. 5 shows an alternative arrangement in which the catalytic burner 507 is heated by contact with the fuel cell device 510. As the gases are relatively quickly heated when they enter the catalytic burner 507, by this arrangement, the necessity of preheating the gases can be eliminated, so that neither a separate heater nor a countercurrent device are necessary. It can also be advantageous for the catalytic burner to be in contact with the anode areas and/or to be integrated more integrally in the fuel cell.

FIG. 6 shows an ascending pipe 660 with a measuring device provided in the anode circuit for determining changes in the liquid balance. Such a device is advantageous as it is much easier to measure the height of a liquid column than the mass flow rate of a liquid.

If the level in the anode circuit is increased, this is an indication that the present liquid balance is positive and the water discharge from the system has to be increased. This can be effected by reducing the performance of the condensing devices (or the fans associated therewith), but also by increasing the volume flow rate on the cathode side, which also effects a higher liquid discharge to the surroundings.

In the example shown in FIG. 6, the measuring device comprises electrical contact pairs 661 which can be short-circuited by the conductive anode fluid containing carbon dioxide. Several pairs of such contacts are stacked, such that various levels of the liquid can be distinguished. Thus, e.g. from the number of conductive or non-conductive contact pairs, one can indirectly infer the present amount of water. At the upper side of the ascending pipe, a liquid-tight device is provided for pressure compensation, e.g. a semi-permeable diaphragm.

Alternative measuring systems are:

Optical methods, for example using light barriers. In this case, the level in the anode circuit is monitored by one or several light barriers. These light barriers recognize whether and to what level a liquid is present on the basis of the various properties of gas or liquid, respectively.

Capacity methods which are based on the fact that the dielectric constants of the gases (ε≈1) and the anode liquids (normally aqueous fuel solutions: ε≈80) are very different. Thus, by an appropriate arrangement of two capacitor plates in the anode circuit, the rise of liquid in the capacitor can be determined by means of the established capacity.

FIG. 7 is a special case of the arrangement which is shown in FIG. 3, wherein the separating device 105 and the condensing device 450 of FIG. 3 are combined to form a fluid separating unit 750.

The fluid separating unit 750 comprises as essential elements condensing devices 51, 52, 53, 54 and a separating chamber 55 for supplying cathode and anode fluids.

As outlined, the condensing devices (e.g. heat exchangers) 51, 52, 53, 54 can be provided inside and outside (in front of) the separating chamber 55. However, it is also possible to provide a single efficient condensing device between the cathode outlet and the separating chamber 55, or else to provide the condensing devices only in and/or at the outer walls of the separating chamber.

The separating chamber 55 is divided into two fluid chambers 55a, 55b: the lower fluid chamber 55a comprises a fluid supply device 56 on the anode side ending in the upper area of the chamber and a liquid discharge device 57.

The upper fluid chamber 55b comprises a fluid supply device 51 on the cathode side via which the gas/liquid mixture from the cathode chamber can be fed to the fuel cell device 710, and a gas discharge device 58 to which, for example, a catalytic burner (not shown) can be connected.

By the combined action of gravity, massively reduced flow velocity and the condensing device 52, in the upper area of the chamber 55b, a part of the liquid is condensed and the gaseous and liquid phase proportions are physically separated, wherein the first can be discharged by means of the gas discharge device 58 and the latter are conducted downwards via a funnel-shaped drain device.

The two fluid chambers 55a, 55b are separated by a tub-like liquid collecting device comprising an overflow pipe ending in the lower chamber 55a, so that liquid substances which are conducted downwards via the drain device, are partially collected by the liquid collecting device and can flow into the lower fluid chamber 55a only when a certain level is achieved (when the upper edge of the overflow pipe is exceeded).

Gaseous substances which come into the lower fluid chamber 55a via the anode fluid supplied to the fluid supply device 56 can escape upwards via a bore in the liquid collecting device, but they have to pass through the liquid collected therein. In the process, gas components, such as methanol, can be dissolved and supplied to the liquid in the lower fluid chamber 55a via the overflow pipe. The thus purified waste gases flow via the funnel pipe upwards towards the gas discharge device 58.

In the lower fluid chamber 55a, a level meter 560 which determines the level of the liquid surface is furthermore provided. As the liquid is electrically conductive due to the CO₂ dissolved therein, the level measuring can be effected via the conductivity: for example, electrode pairs which are short-circuited by the liquid can be provided at different levels. Alternatively, the capacities of capacitors or the changes in the capacities can be used as measured quantity. Also technically easily realizable are optical measuring methods which are based on the different optical properties of the gaseous phase and the liquid. Among these properties are: index of refraction, absorption, transmission. Thus, for example, diode pairs arranged in pairs can be provided of which one each serves as transmitter and the other one as receiver diode by means of which one can detect whether there is any liquid between them.

With the separating chamber 55 which is shown in FIG. 7, thus not only a very effective waste gas purification is possible, but by means of the level measurement one moreover can track whether the amount of liquid in the anode circuit is reduced, remains constant or is increased. In case of changes, corresponding countermeasures can be taken.

The embodiments outlined in the figures only serve for illustrating the invention. The scope of protection of the invention is exclusively defined by the following patent claims.

1. Method for controlling the fluid balance in an anode circuit of a fuel cell system, comprising:
determining a measured quantity characteristic of the amount of liquid and/or changes in the amount of liquid in the fuel cell system, adjusting the cooling capacity of a condensing device and/or adjusting the volume flow rate on the cathode side in response to the determined measured quantity,
cooling gases discharged on the cathode side in the condensing device in order to obtain a condensed liquid,
feeding the condensed liquid into the anode circuit of the fuel cell system.

2. Method for controlling the fluid balance in an anode circuit of a fuel cell system, comprising:
determining a measured quantity characteristic of the amount of liquid and/or changes in the amount of liquid in the fuel cell system, adjusting the cooling capacity of at least one condensing device and/or adjusting the volume flow rate on the cathode side in response to the determined measured quantity,
cooling gases discharged on the cathode side and the anode side in the at least one condensing device in order to obtain a condensed liquid or condensed liquids,
feeding the condensed liquid or liquids into the anode circuit of the fuel cell system.

3. Method according to claim 1, comprising:
heating the waste gases remaining after the condensation procedure at the fuel cell device of the fuel cell system,
passing the heated waste gases through a catalytic burner.

4. Method according to claim 1, comprising:
mounting a catalytic burner at a fuel cell device,
passing the waste gases remaining after the condensation procedure through the catalytic burner.

5. Fuel cell system, comprising:
a fuel cell device,
a device for determining a measured quantity characteristic of the amount of liquid and/or changes of the amount of liquid in the fuel cell system,
at least one condensing device for obtaining a condensed liquid at least from gases discharged on the cathode side,
a controller for adjusting the cooling capacity of the at least one condensing device and/or for adjusting the volume flow rate on the cathode side in response to the determined characteristic measured quantity, and
a device for feeding the condensed liquid to the anode circuit of the fuel cell system.

6. Fuel cell system according to claim 5, comprising:
a heat exchange device for heating gases at the fuel cell device.

7. Fuel cell system according to claim 5, comprising:
a catalytic burner provided at or in the fuel cell device.

8. Method according to claim 2, comprising:
heating the waste gases remaining after the condensation procedure at the fuel cell device of the fuel cell system,
passing the heated waste gases through a catalytic burner.

9. Method according to claim 2, comprising:
mounting a catalytic burner at a fuel cell device,
passing the waste gases remaining after the condensation procedure through the catalytic burner.

10. Fuel cell system according to claim 6, comprising:
a catalytic burner provided at or in the fuel cell device.
